(19) United States
(12) Patent Application Publication
(10) Pub. No.: US 2026/0328001 A1
(43) Pub. Date: Oct. 22, 2026

(54) WALL FORMWORK SYSTEM, USE OF A COMPENSATING PANEL AND METHOD

(71) Applicant: Hünnebeck GmbH, Ratingen (DE)

(72) Inventors: Karl LOJEWSKI, Mülheim (DE); Mario ARIYOSHI, Dinslaken (DE)

(73) Assignee: Hünnebeck GmbH, Ratingen (DE)

(21) Appl. No.: 19/468,098

(22) Filed: Feb. 3, 2026

(30) Foreign Application Priority Data
Feb. 4, 2025 (EP) 25155821.9

(51) Int. Cl. E04G 17/00; B28B 7/22; E04G 11/08; E04G 17/14

(52) U.S. Cl. CPC E04G 17/001; B28B 7/22; E04G 11/08; E04G 17/14

(57) ABSTRACT

The invention relates to a formwork system and a use of a compensating panel in a formwork system for producing a corner region of a concrete component, and a method for producing a corner region of a concrete component. A formwork system for producing a corner region of a concrete component comprises an inner formwork panel for producing an inner surface of the concrete component, the inner formwork panel having an anchor hole, and an outer formwork panel for producing an outer surface of the concrete component, the outer formwork panel having an anchor hole. The inner formwork panel and the outer formwork panel are configured to face each other. A width of the inner formwork panel and the outer formwork panel is different.

### CROSS-REFERENCE TO RELATED PATENT APPLICATIONS

This application claims the benefit of and priority to European Application No. 25155821.9, filed Feb. 4, 2025, the entire disclosure of which is hereby incorporated by reference herein.

### BACKGROUND

The invention relates to a wall formwork system and a use of a compensating panel in a wall formwork system for producing a corner region of a concrete component, and a method for producing a corner region of a concrete component.

### SUMMARY

At least one aspect is directed to a wall formwork system for producing a corner region of a concrete component. The wall formwork system includes an inner formwork panel for producing an inner surface of the concrete component. The inner formwork panel has at least one anchor hole. The wall formwork system includes an outer formwork panel for producing an outer surface of the concrete component. The outer formwork panel has at least one anchor hole. The inner formwork panel and the outer formwork panel are configured to face each other. A width of the inner formwork panel and the outer formwork panel is different. Each of the inner formwork panel and the outer formwork panel has a maximum of two anchor holes in a width direction. A position of the at least one anchor hole of the inner formwork panel is symmetric with respect to a height direction. A position of the at least one anchor hole of the outer formwork panel is symmetric with respect to the height direction.

At least one aspect is directed to a compensating panel in a wall formwork system for producing a corner region of a concrete component. The wall formwork system includes an inner formwork panel for producing an inner surface of the concrete component. The inner formwork panel has at least one anchor hole. The wall formwork system includes outer formwork panel for producing an outer surface of the concrete component. The outer formwork panel has at least one anchor hole. The inner formwork panel and the outer formwork panel are configured to face each other. A width of the inner formwork panel and the outer formwork panel is different. Each of the inner formwork panel and the outer formwork panel has a maximum of two anchor holes in a width direction. The compensating panel is one of the inner formwork panel and the outer formwork panel. A position of the at least one anchor hole of the inner formwork panel is symmetric with respect to a height direction. A position of the at least one anchor hole of the outer formwork panel is symmetric with respect to the height direction.

### BRIEF DESCRIPTION OF THE DRAWINGS

FIG. 1 is a different conventional formwork systems in top view,

FIG. 2 is a conventional formwork system in perspective view,

FIGS. 3 and 4 are different formwork systems according to the invention in top view,

FIG. 5 is a detail of a compensating panel according to the invention,

FIG. 6 is a compensating panel according to the invention,

FIG. 7 is another formwork panel,

FIG. 8 is a perspective view of parts of a formwork system according to the invention, and

FIG. 9 is a front view of parts of a formwork system according to the invention.

### DETAILED DESCRIPTION

A formwork is a mold. Fresh concrete can be poured into the mold. Once the concrete has hardened, the formwork can usually be removed. For example, components of structures such as buildings or bridges can be produced in this way. Examples of components are walls, ceilings, shafts and columns.

A formwork may comprise a plurality of formwork panels. A formwork panel is a panel consisting of wood or plastic, for example. A formwork panel can be planar and/or at least partially curved. A support structure may be present on the rear side of the panel, for example comprising supporting elements such as a frame, longitudinal beams and/or cross beams. The supporting elements may consist of wood or steel, for example. A front surface of the formwork panel contacts and limits the poured concrete and in this way forms the surface of the component. Generally, at least two opposing formwork panels are used to form a section of a component such as a wall. A thickness of the formwork panel is typically measured between the front surface and the most distant point of the support structure in a direction perpendicular to the front surface.

The support structure generally does not protrude from the front of the panel. A formwork panel may comprise one or more anchor holes (also referred to as ties). An anchor rod (also referred to as tie rod) can be inserted through opposite anchor holes in two opposing formwork panels. The ends of an anchor rod can be secured using retaining members such that the anchor rod can then no longer be pulled out of the anchor holes, for example. The anchor rod together with the retaining members forms an anchor. The retaining members can contact or be attached to the rear side of formwork panels, for example, in such a way that an anchor can at least absorb tensile forces, preferably also compressive forces. Two opposing formwork panels can be connected to each other by means of one or more anchors. Retaining members may be tie nuts or anchor nuts, for example.

The above-mentioned features, effects and definitions can be combined individually or in a plurality with the claimed and described subject matter.

Typically, a formwork system is used which comprises formwork panels of different, predefined dimensions. For example, the widths of formwork panels of a formwork system are 30 cm, 45 cm, 60 cm, and 75 cm, so that the panels can be combined in a plurality of different ways. This allows production of almost every wall using a limited set of formwork panels. It is generally desired to keep the number of different parts low.

When installing a formwork for making a corner of a concrete component, a width deviation may arise between the inner formwork panel and the outer formwork panel due to the wall thickness and/or the thickness of the formwork panel. If similar formwork panels are to be arranged opposite each other in the adjacent wall areas, a gap of, for example, 5 cm or 10 cm formed on the inside or outside must first be bridged. This can be filled, for example, with a filling element or filler such as a specially sawn squared timber or a system compensation made of steel.

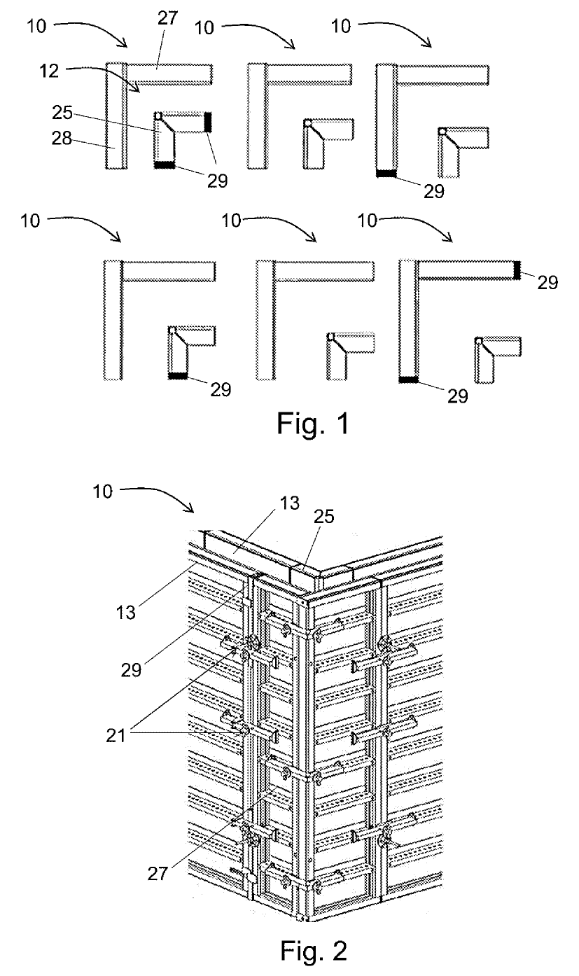

This is visible in FIGS. 1 and 2 showing conventional formwork systems 10 for producing corner regions 12 of a concrete component in a top view. From top left to right and then bottom left to right, six different wall thicknesses are shown which can be produced with the shown formwork systems 10. By way of example, the wall thicknesses are from 20 cm to 45 cm in steps of 5 cm. By way of example, wall thicknesses of the respective two walls are equal. Each formwork system 10 comprises an inner corner piece 25 for producing an inner corner of the concrete component and two outer-corner formwork panels 27, 28. The inner corner is in particular equal-sided. This allows for a more flexible use. A respective first outer-corner formwork panel 27 is shown on the top and a respective second outer-corner formwork panel 28 is shown on the left-hand side.

It shows that for certain wall thicknesses, filling elements 29 are required to compensate for a gap that exists between the inner corner piece and an adjacent formwork panel (not shown) and/or between one of the outer-corner formwork panels 27, 28 and an adjacent formwork panel (not shown). In this way, the adjacent formwork panels for producing the wall can be aligned flush with one another.

FIG. 2 shows a similar formwork system in perspective view. The respective two opposite formwork panels are visible which, between each other, define the region into which the fresh concrete is to be poured. In addition, anchors 21 are shown which fix the opposite formwork panels to each other to keep them in place during concreting. The filling element 29 shown in FIG. 1 and discussed above is visible on the outer side between a first outer-corner formwork panel 27 and a formwork panel 13 shown on the left-hand side. The filling element 29 is for example a squared timber or a steel filler which is held by the two adjacent formwork panels 13, 27.

The task of the invention is to simplify the formwork of a corner of a concrete component. In particular, the use of a filling element should be avoided.

The task is solved by the formwork system according to claim and the use of a compensating panel and a method according to the additional claims. Advantageous embodiments are given in the subclaims.

To solve the task, a formwork system for producing a corner region of a concrete component comprises an inner formwork panel for producing an inner surface of the concrete component. In particular, the inner formwork panel has an anchor hole. The formwork system further comprises an outer formwork panel for producing an outer surface of the concrete component. In particular, the outer formwork panel has an anchor hole. The inner formwork panel and the outer formwork panel are configured to face each other. In particular, a width of the inner formwork panel and the outer formwork panel is different. In particular, the inner formwork panel has a maximum of two anchor holes in a width direction. In particular, the outer formwork panel has a maximum of two anchor holes in a width direction.

With a formwork system according to the invention, bridging gaps using filling elements such as sawn squared timber or system compensations made of steel, for example, is no longer necessary. There is no need for a large number of individual parts, as one formwork panel with a deviating width together with one formwork panel with a standard width is sufficient to compensate for the respective gap. Installation of the formwork is facilitated. Use of the same surface materials of the respective front surface of the different parts is facilitated so that a consistent surface coloring and structure of the concrete component can be achieved. To the contrary, if conventional timber fillers or steel fillers are used, different concrete surface colors are created than with regular panels with plastic sheeting which are positioned adjacent. Avoiding such fillers therefore results in a more homogeneous concrete surface color.

The corner region may or may not comprise the corner itself. The corner may be a wall corner. However, the invention can also be used in any other corner. The corner may be a 90° corner. However, the invention can also be used in corners of any other angle. While the formwork system is generally suitable for producing a corner region, it may generally be suitable for producing any other region of a concrete building such as a wall region.

The inner formwork panel may have a formwork surface for producing or forming a surface of the concrete component. Generally, a formwork surface may be planar. A formwork surface is in particular a closed surface which may be smooth or structured. In particular, the inner formwork panel only has one formwork surface. In particular, the inner formwork panel is flat. Flat in this context means that an extension in one direction is significantly smaller than an extension in the other two perpendicular directions, for example by a factor of at least 5 or 10.

The outer formwork panel may have a formwork surface for producing or forming a surface of the concrete component. The formwork surface may be planar. In particular, the outer formwork panel only has one formwork surface. In particular, the outer formwork panel is flat. The above-mentioned properties of the formwork surface of the inner formwork panel may also apply to the formwork surface of the outer formwork panel.

During concreting, the inner formwork panel and the outer formwork panel face each other. Thus, they delimit opposite surfaces of the component to be produced. The formwork surfaces are in particular arranged parallel. However, a differently angled arrangement is also contemplated. Formwork surfaces of inner and outer formwork panels generally face towards each other. In particular, the inner formwork panel and the outer formwork panel are arranged opposite each other. In particular, the formwork panels are configured to be positioned and fixed relative to each other in this orientation, for example using anchors.

Inner and outer surfaces are surfaces which face towards an interior or an exterior of at least a part of the concrete component. Thus, outer formwork panel(s) define an outside corner and inner formwork panel(s) define an inside corner. The position of the corner in the finished component or structure is irrelevant.

In particular, the width of the inner formwork panel is different from the width of the outer formwork panel. The width is measured along the formwork surface, i.e., in the direction of the surface to be produced. In particular, the widths of the inner formwork panel and the outer formwork panel can be compared in a view along the direction of the corner to be produced, for example in top view in case of a wall corner.

In particular, the inner formwork panel comprises at least one anchor hole. In particular, the outer formwork panel comprises at least one anchor hole.

As described, anchor holes serve to insert an anchor which mechanically connects and holds the opposite formwork panels relative to each other. Thus, outward forces exerted by the liquid concrete are absorbed by the anchor and the formwork panels are held in place. An anchor serves to fix the inner formwork panel and the outer formwork panel relative to each other. The formwork system may comprise an anchor. The anchor may bear against a support structure of the inner and/or outer formwork panel.

In particular, anchor holes are present in fixed distances such as 60 cm, for example. In particular, each formwork panel has an anchor hole in a center region with respect to the width direction and/or the height direction. This allows to firmly fix the formwork panels relative to each other. In case of a component which exceeds a certain height, a plurality of anchor holes may be present above one another at different height positions. Typically, the anchor holes of different height positions have the same or at least similar horizontal positions. In other words, anchor holes are arranged on vertical lines.

Each formwork panel may have a maximum of two anchor holes in a width direction. In other words, during use as intended, no more than two anchor holes are arranged next to each other. Thus, a maximum of one anchor hole has to be closed before concreting. This facilitates use of the formwork system, in particular in comparison to multi-purpose elements having anchor holes every 5 cm in the width direction. However each formwork panel may have one or two or more than two anchor holes in a height direction (one above the other).

In one embodiment, the inner formwork panel is configured to be arranged adjacent to an inner corner piece for producing an inner corner of the concrete component. In particular, the inner formwork panel is configured to be fixed in this position.

The formwork system may comprise the inner corner piece. The inner corner piece is a formwork panel for producing the inner corner of the concrete component or at least a part of the inner corner of the concrete component. The inner corner piece may comprise two formwork panels which are arranged at an angle of 90 degrees, for example, with respect to each other. The two formwork panels may be firmly connected to each other such that non-destructive separation is not possible. Thus, the inner corner piece can be readily used at the construction site. The inner corner piece is separate from each of the formwork panels. The inner corner piece is typically configured to be fixed to the inner formwork panel.

In particular, the inner formwork panel is configured to be positioned adjacent to the inner corner piece such that the front surfaces of the inner formwork panel and the inner corner piece lie in a common plane directly adjacent to one another. In particular, the formwork system comprises means for fixing the inner formwork panel to the inner corner piece. For example, said means may be configured for a force-fit and/or form-fit (positive) connection between a support structure of the inner formwork panel and a support structure of the inner corner piece. The connection is typically such that the adjacent front surfaces of the two components lie in a common plane and directly adjacent to one another.

In particular, the material and/or structure of the front surface of the inner formwork panel equals the material and/or structure of the front surface of the inner corner piece. Thus, the produced concrete component has a consistent surface coloring and/or structure.

In one embodiment, the outer formwork panel is configured to be arranged adjacent to an outer-corner formwork panel for producing at least a part of an outer corner of the concrete component. In particular, the inner formwork panel is configured to be fixed in this position.

The formwork system may comprise the outer-corner formwork panel. The outer-corner formwork panel is a formwork panel for producing at least a part of the outer corner of the concrete component. A part of the outer corner may be a wall section which delimits the outer corner, for example. Together with a similar part that is rotated about 90° with respect to the part, this part forms the outer corner. The outer corner piece is separate from each of the formwork panels.

The outer-corner formwork panel may comprise a first formwork panel which can be arranged at an angle of 90 degrees, for example, with respect to a second formwork panel. Deviating angles are also possible. The outer-corner formwork panel may comprise one or both mentioned formwork panels. Typically, the formwork panels defining the outer corner are positioned and fixed relative to one another at the construction site. The outer-corner formwork panel may comprise means to fix the first and second formwork panels to each other. Preferably, the first and second outer-corner formwork panels are standard panels. This enables more flexible use and reduces the number of parts required.

In particular, the material and/or structure of the front surface of the outer formwork panel equals the material and/or structure of the front surface of the outer-corner formwork panel. Thus, the produced concrete component has a consistent surface coloring and/or structure.

In one embodiment, the width difference is at least 4 cm. The width difference of the inner formwork panel and the outer formwork panel may be at least 1 cm, preferably at least 3 cm or 4 cm and more preferably approx. 5 cm.

In one embodiment, the width difference is at most 11 cm. The width difference may be at most 11 cm or 10 cm, in particular at most 9 cm, more particularly at most 6 cm. Alternatively, the width difference may be at most 16 cm.

In one embodiment, the at least one anchor hole of one of the inner formwork panel and the outer formwork panel is arranged in an off-center position with respect to the width direction. The respective formwork panel having the off-center anchor hole may be referred to as compensating panel or filler panel. In particular, at least one anchor hole of the other one of the inner formwork panel and the outer formwork panel is at a centered position. If the respective formwork panel has two anchor holes in the width direction, both anchor holes are typically arranged off-center.

The width direction is in particular a horizontal direction. Thus, in top view, a distance of the anchor hole to a first end of the respective formwork panel is larger than a distance of the anchor hole to the opposite second end of the formwork panel.

This facilitates alignment of the anchor essentially perpendicular to at least one surface of a respective formwork panel, in particular to surfaces of both the inner and outer formwork panel. Anchor holes can be arranged facing each other at essentially corresponding positions. While perpendicular alignment of the anchor is not strictly necessary, it facilitates installation and removal of the formwork. The respective formwork panel can be used both in upside-up and upside-down position. Thus, only one formwork panel with an off-center anchor hole is required.

In one embodiment, the anchor hole of the wider one of the inner and outer formwork panels is at an off-center position with respect to the width direction. Alternatively, the anchor hole of the narrower one of the inner and outer formwork panels may be at an off-center position with respect to the width direction and/or the anchor hole of the wider one may be at a centered position.

In one embodiment, a distance between the at least one off-center anchor hole and the center of the respective formwork panel, measured in the width direction, equals half the width difference between the inner formwork panel and the outer formwork panel.

This allows a directly opposite arrangement of the two anchor holes. The anchor hole of the compensating panel can be placed directly opposite the anchor hole of a standard panel with which it is combined.

In one embodiment, the one of the inner formwork panel and the outer formwork panel having at least one off-center anchor hole has a marking, in particular a visual marking. In particular, the marking serves to differentiate between a shorter side and a longer side of the respective formwork panel. A visual marking is a marking that can be perceived by the human eye. Alternatively or additionally, the marking may be a palpable marking.

The marking allows a user to easily determine which of the formwork panels of a system has the off-center anchor hole. This enables quicker and easier installation. In particular in combination with a symmetric design with respect to the height direction as discussed below, the marking allows a user to easily determine the direction in which the formwork panel is to be installed.

The shorter side is the side of the formwork panel at which the distance between an outer edge of the formwork panel and the anchor hole is smaller. The longer side is the side at which said distance is longer. A marking may be either on the shorter side or on the longer side. If the marking is placed on the longer side, then the marking usually points towards the corner. If the marking is placed on the shorter side, then the marking usually points towards the wall. Thus, the user can easily know how the compensating panel is rotated (upside up or upside down). Thus, errors on the construction site are impeded.

In particular, the visual marking is clearly visible. In particular, a marking is visible from the rear side of the respective formwork panel. For example, the visual marking may extend over at least 50%, in particular at least 80% or approx. 100% of the height of the formwork panel. The marking layout and position may vary. A marking may be in a form of a sticker and/or be arranged in the anchor area only.

In one embodiment, a position of the at least one anchor hole of the inner formwork panel is symmetric with respect to a height direction. In one embodiment, a position of the at least one anchor hole of the outer formwork panel is symmetric with respect to a height direction.

This enables use of the respective formwork panel both upside up and upside down. In particular in combination with off-centered anchor holes, this is advantageous, as one formwork panel can be used in two different arrangements so that an additional formwork panel for this purpose is no longer required.

Symmetric with respect to the height direction relates to a mirror symmetry with respect to a plane of symmetry which is arranged perpendicular to a formwork surface of the respective formwork panel and divides the height of the formwork panel in two equal halves.

If there is more than one anchor hole, the positions of the more than one anchor holes are symmetric with respect to the height direction. For example, the distance of an uppermost anchor hole to the upper edge of the formwork panel corresponds to the distance of a lowermost anchor hole with respect to the lower edge.

The anchor holes of the formwork panel with the centered anchor holes may be arranged rotationally symmetrically.

In one embodiment, the formwork system further comprises an anchor which can be inserted through the anchor hole of the outer formwork panel and the anchor hole of the inner formwork panel to fix the outer formwork panel and the inner formwork panel relative to each other at least in the outward direction and, in particular, also in the inward direction. In particular, the anchor is configured for positive fixing.

In particular, the formwork system is configured such that in the inserted state, the anchor is essentially or completely perpendicular to the front surface of the inner formwork panel and/or the outer formwork panel.

In one embodiment, a width of the inner formwork panel is at least 25 cm, in particular at least 35 cm. In one embodiment, a width of the outer formwork panel is at least 25 cm, in particular at least 35 cm. The width is measured along the width direction.

In particular, the width of the inner formwork panel is at least 25 cm, more particularly at least 30 cm and particularly preferably at least 35 cm. In particular, the width of the outer formwork panel is at least 25 cm, more particularly at least 30 cm and particularly preferably at least 35 cm. In particular, the width of the inner and/or outer formwork panel is at most 80 cm. The width may be 65 cm, for example. The minimum width of the formwork panel ensures that there is sufficient space for an anchor hole and/or for fixing the formwork panel to adjacent and/or opposite formwork panels. In this case, typically, a “normal” formwork panel is combined with somewhat wider or narrower formwork panel, for example by 5 cm. Thus, only one additional part is required.

In one embodiment, a width of the inner formwork panel is at least 4 cm, in particular at least 9 cm. In one embodiment, a width of the outer formwork panel is at least 4 cm, in particular at least 9 cm.

The width of the inner formwork panel may be at least 4 cm, in particular at least 5 cm, more particularly at least 6 cm, preferably at least 9 cm, particularly at least 10 cm, more particularly at least 11 cm and/or at most 16 cm, particularly at least 15 cm, in particular at most 14 cm, more particularly at most 11 cm, 10 cm or 9 cm. The width of the outer formwork panel may be at least 4 cm, in particular at least 5 cm, more particularly at least 6 cm, preferably at least 9 cm, more particularly at least 11 cm and/or at most 16 cm, in particular at most 14 cm, more particularly at most 11 cm, 10 cm or 9 cm. Typically, the width difference is 5 cm. Such narrow formwork panels may be referred to as fillers. Typically, a filler does not have a support structure.

The width of the inner formwork panel may be one of the following: 4 cm, 6 cm, 9 cm, 11 cm, 14 cm, 15 cm, 16 cm, 19 cm, 20 cm, 25 cm, 29 cm, 30 cm, 31 cm, 34 cm, 35 cm, 36 cm, and 40 cm. The width of the outer formwork panel may be one of the following: 4 cm, 6 cm, 9 cm, 11 cm, 14 cm, 15 cm, 16 cm, 19 cm, 20 cm, 25 cm, 29 cm, 30 cm, 31 cm, 34 cm, 35 cm, 36 cm, and 40 cm. In particular, in the case of 4 cm, 6 cm, 9 cm, 11 cm, 14 cm, 16 cm, or 19 cm, a panel may be a compensation filler without a support structure. In the case of the remaining widths, a panel may be a compensation panel having a support structure.

Possible pairs of widths of the inner formwork panel and the outer formwork panel are 4 cm and 9 cm, 6 cm and 11 cm, 11 and 16 cm, 14 cm and 19 cm, 15 cm and 20 cm, 20 cm and 25 cm, 25 cm and 30 cm, 29 cm and 34 cm, 30 cm and 35 cm, 31 cm and 36 cm, 35 cm and 40 cm.

In one embodiment, the inner formwork panel comprises a support structure on its rear side. In one embodiment, the outer formwork panel comprises a support structure on its rear side. The support structure may comprise one or more supporting elements such as a frame, longitudinal beams and/or cross beams. The rear side is the side facing away from the front surface for contacting the concrete. In comparison to compensating piece such as a squared timber, the support structure structurally strengthens the respective formwork panel. In addition, fixing is possible using the support structure and thus, very easily.

Another aspect of the invention is a use of a compensating panel in a formwork system. The formwork system serves for producing a corner region of a concrete component. Said formwork system comprises an inner formwork panel for producing an inner surface of the concrete component and an outer formwork panel for producing an outer surface of the concrete component. The inner formwork panel and the outer formwork panel are configured to face each other. In particular, a width of the inner formwork panel and the outer formwork panel is different. Said compensating panel is one of the inner formwork panel and the outer formwork panel. In particular, the inner formwork panel has an anchor hole and/or the outer formwork panel has an anchor hole.

In particular, the compensating panel is used for compensating a width difference introduced by an outer panel’s width when attached at a right angle to an adjacent formwork panel with which together it defines the outer corner. All features, embodiments and advantages of the formwork system described above may also apply to the use and vice versa.

In particular, a compensating panel is a panel which has an off-center anchor hole. Therefore, a compensating panel is different from the normal formwork panels of such a formwork system. In particular, the anchor hole or anchor holes of the compensating panel are symmetric with respect to the height direction.

Another aspect of the invention is a method for producing a corner region of a concrete component, using the formwork system according to the invention. The method comprises positioning the inner formwork panel and the outer formwork panel relative to each other such that the inner formwork panel and the outer formwork panel face each other. In particular, the respective front surfaces of the inner and outer formwork panel face each other. The method may further comprise fixing the inner formwork panel and the outer formwork panel relative to each other using at least one anchor. Fixing may comprise inserting an anchor rod through opposite anchor holes of the inner and outer formwork panels and, in particular, attaching retaining members to the parts of the anchor rod protruding away from the rear sides or support structures of the formwork panels.

The method further comprises concreting. Concreting means pouring concrete in the installed formwork and, in particular, hardening of the concrete. Before concreting, in particular, the sides of the formwork are closed.

In the following, exemplary embodiments of the invention are also explained in more detail with reference to figures. Features of the exemplary embodiments can be combined individually or in a plurality with the claimed objects, unless otherwise indicated. The claimed scopes of protection are not limited to the exemplary embodiments.

FIGS. 1 and 2 have already been discussed above in the course of the review of the state of the art.

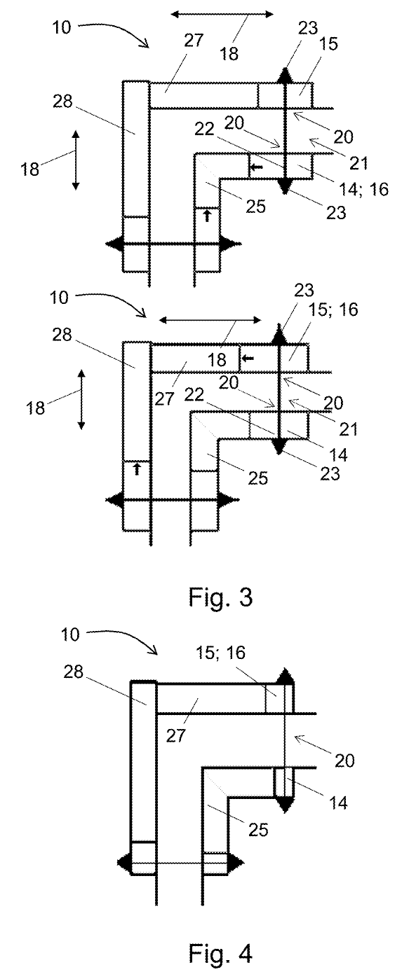

The upper view of FIG. 3 shows the formwork system 10 according to the invention. A first outer-corner formwork panel 27 and a second outer-corner formwork panel 28 are fixed to one another at a right angle to form the outer corner of a concrete component. For example, a corner of a residential building can be produced in this way. The opposite inner corner is to be formed using the inner corner piece 25. Both the formwork panels 27, 28 and the inner corner piece 25 comprise a front surface facing inwards towards the concrete and a support structure (not shown) on the rear side for supporting the front surface.

As the width of the first outer-corner formwork panel 27 is not equal to the sum of the thickness of the concrete wall and the width of the inner corner piece 25 measured in the width direction 18 of the first outer-corner formwork panel 27, the first outer-corner formwork panel 27 and the inner corner piece are not flush. Therefore, compensation is required on the right-hand side. The same applies to the situation on the side shown at the bottom of the upper view of FIG. 3. In both cases, the inner corner piece 25 is shorter than the respective outer-corner formwork panel 27 and 28, respectively.

For compensation of this length difference, the formwork system 10 comprises an inner formwork panel 14 for producing an inner surface of the concrete component, the inner formwork panel 14 having an anchor hole 20, and an outer formwork panel 15 for producing an outer surface of the concrete component, the outer formwork panel 15 having an anchor hole 20. The inner formwork panel 14 and the outer formwork panel 15 are configured to face each other. A width of the inner formwork panel 14 and the outer formwork panel 15 is different, as the width of the outer formwork panel 15 is smaller than the width of the inner formwork panel 14. In this way, the right-hand side faces of the inner formwork panel 14 and the outer formwork panel 15 are flush. The width is measured along the width direction 18 indicated by the double arrow. For the right-hand side, the width direction 18 is horizontal, while for the side shown on the bottom, the width direction 18 is vertical.

An anchor 21 is present which fixes the inner formwork panel 14 and the outer formwork panel 15 to each other. Generally, an anchor 21 may comprise an anchor rod 22 and retaining members 23 which can be fixed to the anchor rod. In particular, the anchor rod 22 and the retaining members 23 are configured for form-fit or positive fixing. Through the anchor holes 20 of the opposite inner formwork panel 14 and outer formwork panel 15, an anchor rod 22 has been inserted. Retaining members 23 have been fixed to the ends of the anchor rod 22 that protrude from the respective formwork panel 14, 15. In particular, retaining members 23 are positively connected to the anchor rod and/or in such a way that an outward force exerted by the poured concrete is absorbed by the anchor rod.

Although only described and labelled for the right-hand side, the same applies to the side shown on the bottom of the upper view of FIG. 3.

In the exemplary embodiment shown in the upper view of FIG. 3, the wall thickness is 25 cm. The width of the inner corner piece 25 in each width direction 18 is 30 cm. The width of each outer formwork panel is 30 cm and the width of each inner formwork panel is 35 cm. The width of the first outer-corner formwork panel 27 is 60 cm and the width of the second outer-corner formwork panel 28 is 75 cm. The thickness of the inner formwork panel 14, of the outer formwork panel 15, of the first outer-corner formwork panel 27, of the second outer-corner formwork panel 28 and/or of the inner corner piece 25 is approx. 15 cm. For example, the width may be 14cm and an offset of 1cm is contemplated to integrate the respective panel into the 15 cm pattern. In particular, the thickness of the mentioned elements is approximately equal. As the inner formwork panel 14 has an off-center anchor hole 20, it serves as the compensating panel 16. To the contrary, the outer formwork panels 15 have a centered anchor hole 20. In addition, the compensating panel 16 usually has a greater width than its opposing panel.

The lower view of FIG. 3 is similar. The only difference is that in this case, the respective outer-corner formwork panels 27, 28 are shorter. Thus, the outer formwork panels 15 have a larger width than the inner formwork panels 14. As the outer formwork panels have an off-center anchor hole 20, they serve as compensating panels 16. The inner formwork panels 14 have a centered anchor hole 20. Reference is made to the description above. Deviating from the above-mentioned measures, the wall thickness is 20 cm here, the width of the first outer-corner formwork panel 27 is 45 cm and the width of the second outer-corner formwork panel 28 is 60 cm.

Arrows represent the markings in FIG. 3. Just like the markings, the arrows always point towards the corner. It can be seen in the upper view that the formwork panel 14 adjoining the inner corner piece 25 on the right-hand side and the formwork panel 14 adjoining the inner corner piece 25 on the left-hand side are oriented differently. For example, one is upside-up and the other one is upside-down.

Another example of a formwork system 10 according to the invention is shown in FIG. 4. Here, also, the wall thickness is 25 cm by way of example. The width of the inner formwork panel 14 is 10 cm and the width of the outer formwork panel 15 is 15 cm. Also here, the outer formwork panels 15 have an off-center anchor hole 20 and therefore serve as compensating panels 16. To the contrary, the inner formwork panels 14 have a centered anchor hole 20. The width of the inner corner piece 25 is 40 cm or 30 cm in each direction. Apart from this, the shown example corresponds to the example shown in the upper view of FIG. 3.

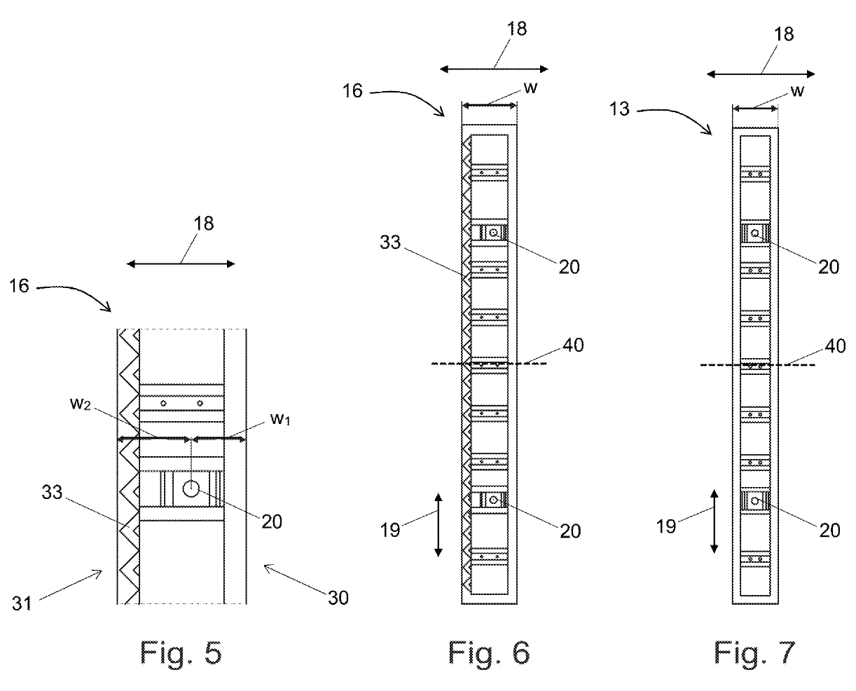

FIGS. 5 and 6 show a compensating panel 16 with an off-centered anchor hole 20. The compensating panel 16 may be part of the formwork system according to the invention in front view. FIG. 5 shows an enlarged detail. The compensating panel 16 may be used as an inner formwork panel or an outer formwork panel of the formwork system. In this example, the width w of the compensating panel 16 is 35 cm. The first width w1, corresponding to the distance between the center of the anchor hole 20 and the right-hand edge is 15 cm. The second width W2, corresponding to the distance between the center of the anchor hole 20 and the left-hand edge is 20 cm. Therefore, the anchor hole 20 is off-center. The longer side 31 is on the left-hand side and the shorter side 30 is on the right-hand side.

The distance between the off-center anchor hole 20 and the center of the compensation panel 16, measured along the width direction 18, is 2.5 cm. The compensating panel 16 shown here is preferably used together with a panel having a width of 30 cm or 40 cm as the respective other (outer or inner) formwork panel. In this case, the 2.5 cm mentioned above correspond to half the width difference between the inner and outer formwork panels.

The compensating panel 16 has an optical marking 33 in the exemplary shape of a zigzag line which is in particular color. This enables a user to unmistakably identify the longer side 31 on the construction site.

FIG. 7 shows a formwork panel 13 which may be used together with the compensating panel 16 of FIGS. 5 and 6 in front view. If the compensating panel 16 is the inner formwork panel, formwork panel 13 of FIG. 7 is the outer formwork panel, and vice versa. Anchor holes 20 of the formwork panel 13 are centered with respect to the width direction 18. Formwork panel 13 does not comprise the described marking.

Both FIGS. 6 and 7 show that in each case, the anchor holes 20 are symmetric with respect to the height direction 19. For clarification, the respective plane of symmetry 40 is depicted as a line.

In an alternative embodiment, the compensating panel 16 shown in FIG. 6 could also have two anchor holes in the width direction, i.e. two anchor holes side by side in each height level. The distance between the first anchor hole and the central vertical axis would then correspond to the distance between the second anchor hole and the central vertical axis. The width of the compensating panel 16 would in particular remain the same.

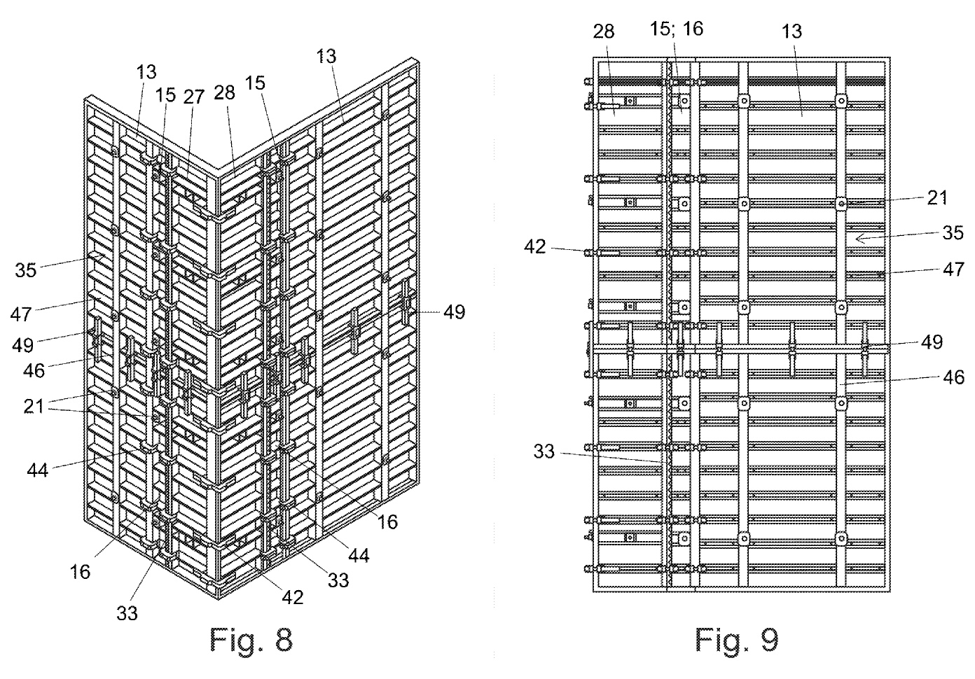

FIGS. 8 and 9 show an outer part of a formwork system according to the invention. The rear side of the formwork panels faces the viewer, whereas the front surface for contacting the concrete faces away and is therefore not visible. A left-hand first outer-corner formwork panel 27 and a right-hand second outer-corner formwork panel 28 together form an outer-corner formwork panel for forming the outer corner. These outer-corner formwork panels 27, 28 are fixed to one another using corner clamps 42. On both sides of the outer-corner formwork panel, outer formwork panels 15 are arranged which are used as compensating panels 16. Adjacent to outer formwork panels 15 on both sides of the outer formwork panels 15, regular formwork panels 13 are arranged to form the respective walls.

Compensating panels 16 have a respective marking 33 on their longer sides as shown in FIGS. 5 and 6. Anchor holes of the compensating panels 16 are off-center, as shown in FIG. 9. The inner formwork panels (not shown) to be arranged opposite to the outer formwork panels 15 typically have a standard width which is slightly larger or smaller than the width of the compensating panels 16.

Respectively adjacent formwork panels are arranged such that the adjacent front surfaces are flush to form a flat concrete surface. Respectively adjacent formwork panels, including the outer formwork panels 15 and the formwork panels 13, are fixed to one another, such that the forces of the fresh concrete can be absorbed. For this purpose, clamps 44 are used. Clamps 44 are in particular configured for positive connection of adjacent formwork panels.

The support structure 35 of all formwork panels, including outer formwork panels 15, outer-corner formwork panels 27, 28 and formwork panels 13, comprises vertical beams 46 and horizontal beams 47. Anchor holes are arranged in beams, for example in vertical beams 46, to ensure mechanical stability of anchors 21. Clamps 44 and corner clamps 42 engage beams, in particular vertical beams 46, and/or a frame of the support structure 35 that protrudes backwards to ensure mechanical stability of the respective connection. Corner clamps 42 are in particular configured for positive connection of adjacent formwork panels arranged at an angle of 90°, for example.

In order to reach a required height, by way of example, each of the formwork panels 13, 15, 27, 28 is duplicated. Each duplicate is stacked above the respective first formwork panel. In other words, there are two layers in which similar or identical formwork panels 13, 15, 27, 28 are stacked one above the other. Above a first formwork panel 13, there is another formwork panel 13, above a first compensating panel 16 there is another compensating panel, and so on. Preferably, each duplicate panel is of the same height as the respective first formwork panel. However, different heights are principally also contemplated. In particular, the height of each formwork panel 13, 15, 27, 28 within a lower layer is the same. In particular, the height of each formwork panel 13, 15, 27, 28 within an upper layer is the same. Duplicate formwork panels 13, 15, 27, 28 are optional, depending on the required height of the corner region and/or wall, and on the height of the respective panels. Generally, there may be more than two layers, such as, for example three, four or five layers, in order to reach the required height.

Fixing means 49 are present to fix a formwork panel 13, 15, 27, 28 of the lower layer to the formwork panel 13, 15, 27, 28 above it. Fixing means 49 may be configured as panel clamps and/or for force-fit and/or positive connection. Fixing means 49 may comprise vertical bars which are attached to both vertically adjacent formwork panels 13, 15, 27, 28.

### LIST OF REFERENCE SIGNS

formwork system 10

corner region 12

formwork panel 13

inner formwork panel 14

outer formwork panel 15

compensating panel 16

width direction 18

height direction 19

anchor hole 20

anchor 21

anchor rod 22

retaining member 23

inner corner piece 25

first outer-corner formwork panel 27

second outer-corner formwork panel 28

filling element 29

shorter side 30

longer side 31

marking 33

support structure 35

plane of symmetry 40

corner clamp 42

clamp 44

vertical beam 46

horizontal beam 47

fixing means 49

width w

first width w₁

second width W₂

What is claimed is:

1. A wall formwork system for producing a corner region of a concrete component, comprising:
an inner formwork panel for producing an inner surface of the concrete component, the inner formwork panel having at least one anchor hole; and
an outer formwork panel for producing an outer surface of the concrete component, the outer formwork panel having at least one anchor hole,
wherein the inner formwork panel and the outer formwork panel are configured to face each other,
wherein a width of the inner formwork panel and the outer formwork panel is different,
wherein each of the inner formwork panel and the outer formwork panel has a maximum of two anchor holes in a width direction, and
wherein a position of the at least one anchor hole of the inner formwork panel is symmetric with respect to a height direction, and
wherein a position of the at least one anchor hole of the outer formwork panel is symmetric with respect to the height direction.

2. The wall formwork system of claim 1, wherein each of the inner formwork panel and the outer formwork panel has only one anchor hole in a width direction.

3. The wall formwork system of claim 1, wherein the inner formwork panel is configured to be arranged adjacent to an inner corner piece for producing an inner corner of the concrete component and fixed in this position.

4. The wall formwork system of claim 1, wherein the outer formwork panel is configured to be arranged adjacent to an outer-corner formwork panel for producing at least a part of an outer corner of the concrete component and fixed in this position.

5. The wall formwork system of claim 1, wherein a width difference between the width of the inner formwork panel and the width of the outer formwork panel is at least 4 cm and/or at most 16 cm.

6. The wall formwork system of claim 1, wherein the at least one anchor hole of one of the inner formwork panel and the outer formwork panel is arranged in an off-center position with respect to the width direction.

7. The wall formwork system of claim 6, wherein one of the inner formwork panel and the outer formwork panel having at least one off-center anchor hole has a marking to differentiate between a shorter side and a longer side of the respective formwork panel.

8. The wall formwork system of claim 7, wherein a distance between the at least one off-center anchor hole and a center of the respective formwork panel, measured in the width direction, equals half the width difference between the inner formwork panel and the outer formwork panel.

9. The wall formwork system of claim 1, further comprising an anchor which can be inserted through the anchor hole of the outer formwork panel and the anchor hole of the inner formwork panel to fix the outer formwork panel and the inner formwork panel relative to each other at least in an outward direction.

10. The wall formwork system of claim 1, wherein the width of the inner formwork panel is at least 25 cm, in particular at least 35 cm, and/or the width of the outer formwork panel is at least 25 cm, in particular at least 35 cm.

11. The wall formwork system of claim 1, wherein the width of the inner formwork panel is at least 4 cm, in particular at least 9 cm, and/or the width of the outer formwork panel is at least 4 cm, in particular at least 9 cm.

12. The wall formwork system of claim 1, wherein the inner formwork panel comprises a support structure on a rear side thereof and the outer formwork panel comprises a support structure on a rear side thereof.

13. A method for producing the corner region of the concrete component, using the wall formwork system of claim 1, the method comprising:
positioning the inner formwork panel and the outer formwork panel relative to each other such that the inner formwork panel and the outer formwork panel face each other;
fixing the inner formwork panel and the outer formwork panel relative to each other using at least one anchor, and
concreting.

14. A compensating panel in a wall formwork system for producing a corner region of a concrete component, the wall formwork system comprising:
an inner formwork panel for producing an inner surface of the concrete component, the inner formwork panel having at least one anchor hole; and
an outer formwork panel for producing an outer surface of the concrete component, the outer formwork panel having at least one anchor hole,
wherein the inner formwork panel and the outer formwork panel are configured to face each other,
wherein a width of the inner formwork panel and the outer formwork panel is different,
wherein each of the inner formwork panel and the outer formwork panel has a maximum of two anchor holes in a width direction, the compensating panel being one of the inner formwork panel and the outer formwork panel, and
wherein a position of the at least one anchor hole of the inner formwork panel is symmetric with respect to a height direction, and
wherein a position of the at least one anchor hole of the outer formwork panel is symmetric with respect to the height direction.
